(19) United States
(12) Patent Application Publication
(10) Pub. No.: US 2026/0286089 A1
(43) Pub. Date: Sep. 24, 2026

(54) SILICON-CONTAINING THERMALLY CONDUCTIVE PASTES

(71) Applicant: Wacker Chemie AG, Munich (DE)

(72) Inventor: Sebastian Knoer, Munich (DE)

(73) Assignee: Wacker Chemie AG, Munich (DE)

(21) Appl. No.: 18/873,775

(22) PCT Filed: Jul. 11, 2022
(86) PCT No.: PCT/EP2022/069349

§ 371 Date: Dec. 11, 2024

(51) Int. Cl. C08K 3/02; C08G 77/04

(52) U.S. Cl. CPC C08K 3/02; C08G 77/04; C08K 2003/023; C08K 2201/001; C08K 2201/003

(57) ABSTRACT

A non-crosslinkable, heat-conducting silicone composition (Y) includes 5-50% by volume of at least one non-crosslinkable silicone composition (S) and 50-95% by volume of at least one thermally conductive filler (Z) having a thermal conductivity of at least 5 W/mK. The non-crosslinkable, thermally conductive silicone composition (Y) has a thermal conductivity of at least 0.6 W/mK and at least 20% by volume of metallic silicon particles that are present as thermally conductive fillers (Z) have median diameter x50 in the range of 30-200 μm, are predominately rounded, and characterized in that the width/length ratio (aspect ratio w/l) is at least 0.76, and have a distribution range SPAN ((x90−x10)/x50) of at least 0.28.

The present invention relates to heat-conducting silicone compositions, and to the production and use thereof.

### PRIOR ART

Heat-conducting silicone compositions find wide use for heat management in the automobile and electronics industries. Examples of important presentation forms include heat-conducting adhesives, heat-conducting pads, gap fillers, encapsulation compounds and pastes. A thermal paste is a paste that improves heat transfer between two objects, for example the cooling surface/housing of an integrated circuit and a heat sink. The assembly areas of heat sinks and components always contain greater or lesser depths of unevenness and variances from planarity. Thermal pastes fill this unevenness and hence enable better heat transfer to cooling housings or heat sinks.

The prior art includes different thermally conductive fillers that are added to increase the thermal conductivity of silicone compositions. However, these have serious disadvantages. Ceramic fillers, for example aluminium oxide, have a very high density and hence increase the weight of the components very significantly. Moreover, they are comparatively costly. Metallic fillers, for example aluminium powders or silver powders, are electrically conductive, which is unacceptable for many applications. Many metals and alloys are additionally comparatively costly.

Many further fillers of high thermal conductivity, for example carbon nanotubes, boron nitride and aluminium nitride, on account of their comparatively high costs, can also be used only to a limited degree, or in small amounts or specific applications.

The prior art includes various heat-conducting silicone compositions containing silicon particles as heat-conducting filler. These are comparatively light and inexpensive. Moreover, silicon, being a semiconductor, has extremely low electrical conductivity. However, the silicon particles according to the prior art are unsuitable for use in electrical vehicles and electronic components:

The Si particles used in the prior art are usually obtained via grinding methods. A disadvantage is that such particles have a high surface area and bind a very large amount of polymer. This increases the viscosity of the silicone composition very significantly. It is possible to produce only mixtures having comparatively low filling levels and low thermal conductivity. In the case of higher filling levels, the composition becomes very stiff and can no longer be processed by conventional methods, for example dispensers. It is also found that silicone compositions containing ground silicon particles have comparatively high combustibility.

The use of silicon particles smaller than 30 μm is disadvantageous since such small particles have a comparatively low minimum ignition energy and hence present a dust explosion hazard and require complex and costly safety precautions in industrial processing.

JP2019131669A2 teaches the use of metallic Si particles of size 0.1-200 μm and having electrically insulating coating as thermally conductive fillers for siloxane-free organic resins. The particles can be produced via thermal breakdown or melting or grinding methods, or be obtained from polishing or grinding methods. The particles are provided with an electrically insulating coating in a separate process step. In the examples, JP2019131669A2 discloses organic resins containing up to 65% by volume of ground Si particles having an average particle size of 32 μm and having a thermal conductivity of up to 7 W/mK. A disadvantage is the use of ground particles having comparatively high combustibility. The vulcanizates disclosed are nonelastic and therefore unsuitable for use as a gap filler in lithium ion batteries.

US2016122611 teaches electrically and thermally conductive silicone elastomer compositions containing a thermally conductive filler smaller than 30 μm, more preferably 2 to 8 μm, in combination with a carbon black. The thermally conductive filler may be a silicon powder. What are disclosed in the examples are compositions containing up to 60% by weight of ground Si particles having an average particle size of 5 μm or up to 46% by weight of ground Si particles having an average particle size of 40 μm. The thermal conductivity of the compositions is up to 1.0 W/mK. A disadvantage is the use of ground particles that are of comparatively high combustibility and permit only compositions having a comparatively low filling level and low thermal conductivity.

US2007135555 teaches heat-crosslinking, thermally conductive silicone compositions containing spherical metallic Si particles that are produced via a melting method, or ground metallic Si particles, each having an average particle size of up to 100 μm, more preferably of 2 to 25 μm. What are disclosed in the examples are compositions containing up to 71% by weight of ground Si particles having an average particle size of 12 μm or up to 71% by weight of spherical Si particles having an average particle size of 5 μm, each in combination with oxidic fillers, for example Fe₂O₃ or Al₂O₃. The thermal conductivity of the compositions is up to 1.2 W/mK. A disadvantage is the use of very small Si particles that are comparatively highly combustible and permit only compositions having a comparatively low filling level and low thermal conductivity.

US2007117920 teaches heat-crosslinking, thermally conductive silicone compositions containing spherical or ground, metallic Si particles having an average particle size of 2 to 100 μm, more preferably 2 to 25 μm. What are disclosed in the examples are compositions containing up to 67% by weight of ground Si particles having an average particle size of 5 to 12 μm, as the sole filler or in combination with Al₂O₃. The viscosity of the mixtures is in the range from 30 000 to 260 000 mPa·s at a thermal conductivity of up to 1.0 W/mK. A disadvantage is the use of very small Si particles that are comparatively highly combustible and permit only compositions having comparatively high viscosity, low filling level and low thermal conductivity.

US2001051673 teaches heat-crosslinking, thermally conductive silicone elastomer compositions containing platelet-shaped particles having an average particle size of 0.1 to 350 μm or round particles having an average particle size of 0.1 to 50 μm, preferably 0.5 to 20 μm, composed of a magnetic silicon-containing Fe—Si alloy, preference being given to platelets. What are disclosed in the examples are compositions containing 30% by volume of spherical Fe—Si particles, consisting of 97% by weight of Fe and 3% by weight of Si, having an average particle size of 8 μm in combination with 40% by volume of Al₂O₃ particles. The thermal conductivity is 4.0 W/mK. A disadvantage is the use of very small Fe—Si particles having a very high iron content. As a result, the particles are electrically conductive, have a comparatively high density and are comparatively highly combustible. An additional disadvantage is the use of large amounts of Al₂O₃, which means that the density of the composition is very high.

U.S. Pat. No. 4,292,223 teaches crosslinkable, thermally conductive silicone elastomer compositions containing metallic particles, for example silicon, preference being given to alloys, having an average particle size of 40 to 300 μm. The particles may be of spherical or irregular shape, having a length-to-width ratio of up to 8 (corresponding to an aspect ratio (w/l) according to ISO 9276-6 of not less than 0.125). This results in a very broad definition of the possible particle form, since the particles can be either spherical, corresponding to a length-to-width ratio of 1, or rod-shaped, where the length may be greater by a factor of 8 than the width. What are disclosed are compositions containing 28% by weight of ground Si particles having an average particle size of 44 μm, without disclosure of the w/l ratio. A disadvantage is the use of ground particles, which are comparatively highly combustible. Moreover, ground particles have a comparatively high surface area, and therefore compositions containing ground particles have a comparatively high viscosity and are difficult to process. The crosslinked materials have low flexibility and are brittle.

US2006228542 describes thermally conductive elastomers containing two thermally conductive fillers of different size. The elastomer may be a silicone inter alia. The first thermally conductive filler is formed from an electrically insulating and thermally conductive ceramic. As one of several examples of a suitable ceramic material, “silicone” is mistakenly listed rather than “silica”. But it is entirely clear to the person skilled in the art when reading this disclosure that what are actually meant are silica ceramics, since silicon metal is not a ceramic, but fused silica ceramics (i.e. SiO₂ ceramics) are very well known. The first thermally conductive filler additionally has a monomodal distribution and an average particle size of at least 20 μm. It is disclosed that the first filler particle is spheroidal or spherical, and may also be hollow. It has a preferred average particle size of 30 to 95 μm with a standard deviation of 15 to 40 μm. This is an extremely non-specific definition of the possible distribution range, and so the particles could have a very narrow or very broad distribution.

This is shown by way of example by the following observations: a standard deviation of 40 μm with an average particle size of 30 μm corresponds to a very broad grain size distribution, whereas a standard deviation of 15 μm with an average particle size of 95 μm corresponds to a very narrow grain size distribution. There are no teachings in US2006228542 as to the influence of the standard deviation of the grain size distribution of the filler on the properties of the elastomer.

It was therefore an object of the present invention to provide non-crosslinkable, heat-conducting silicone compositions that do not show the abovementioned disadvantages of the prior art, and which combine the properties of low density, low costs and high thermal conductivity.

This object is achieved by the inventive non-crosslinkable, heat-conducting silicone compositions (Y) which contain comparatively large Si particles having an average particle size of 30 to 200 μm, of predominantly rounded form, and which simultaneously have a particularly large or broad particle distribution range. Completely surprisingly, it was found in experiments that these inventive non-crosslinkable, heat-conducting silicone compositions (Y) have distinctly reduced combustibility.

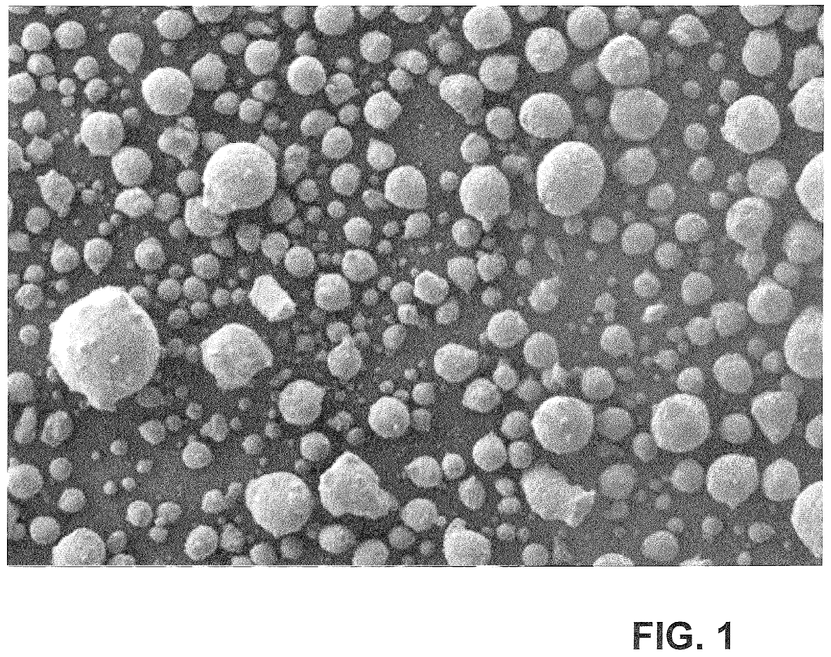

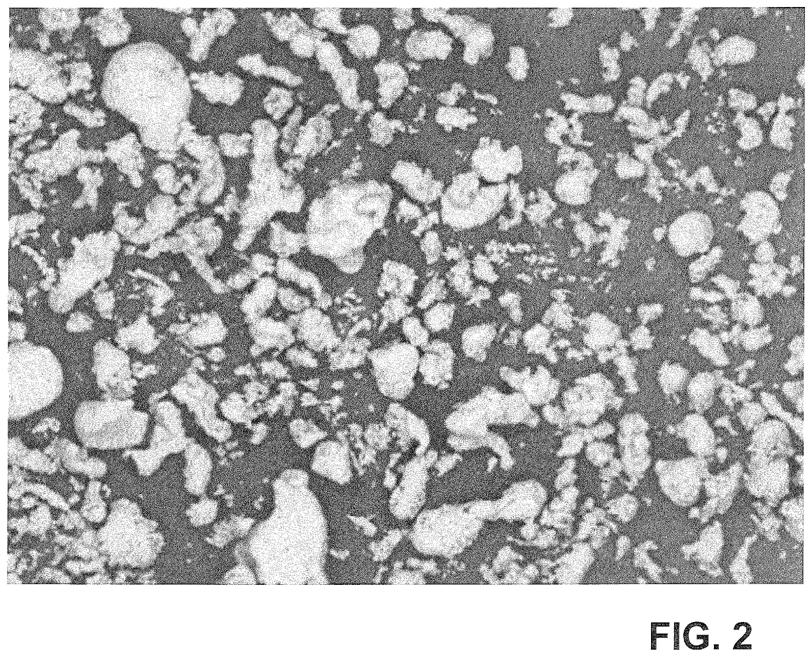

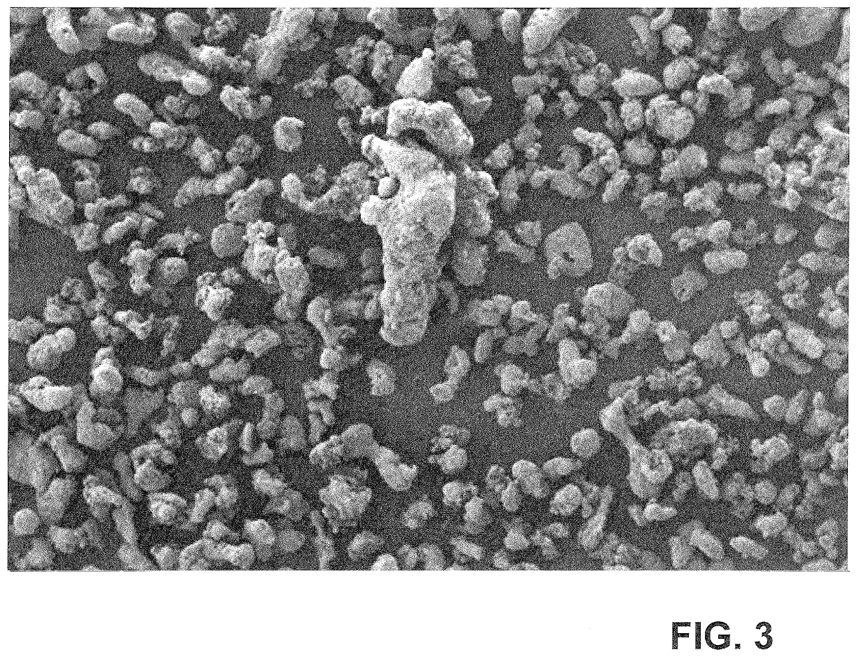

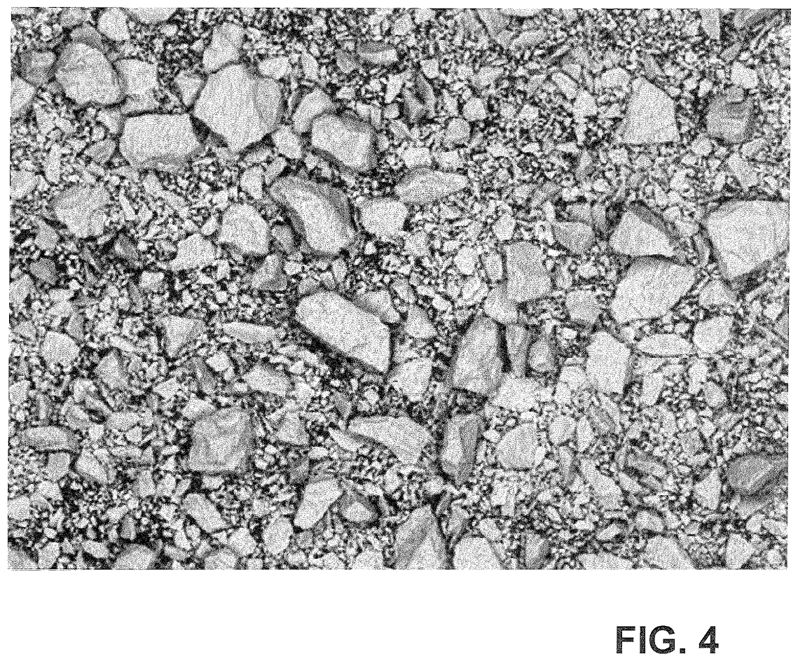

Si particles of “predominantly rounded” form in the context of the present invention are understood to mean those having a spherical to oval shape with smooth surfaces. They could also be referred to as potato-shaped. FIG. 1 shows, by way of example, the inventive, predominantly rounded shape of these Si particles. Noninventive Si particle shapes are shown by FIG. 2 with “spattered” particles, FIG. 3 with “nodular” particles, and FIG. 4 with “angular” and “sharp” particles. Inventive metallic Si particles are thus not spattered, nodular, or angular or sharp. But they may contain such particles to the degree of an impurity without disruption of their inventive effect.

The properties of the Si particles according to FIGS. 1 to 4 are additionally shown in the following table.

| FIG. | X50 (mm) | w/l | SPHT | |
|---|---|---|---|---|
| 1 | 98 | 0.84 | 0.87 | inventive |
| 2 | 38 | 0.68 | 0.70 | noninventive |
| 3 | 73 | 0.67 | 0.72 | noninventive |
| 4 | 37 | 0.67 | 0.76 | noninventive |

The present invention provides a non-crosslinkable, heat-conducting silicone composition (Y) comprising
5-50% by volume of a non-crosslinkable silicone composition (S) and
50-95% by volume of at least one thermally conductive filler (Z) having a thermal conductivity of at least 5 W/mK, with the proviso that
the non-crosslinkable, heat-conducting silicone composition (Y) has a thermal conductivity of at least 0.6 W/mK, and that
at least 20% by volume of metallic silicon particles present as thermally conductive fillers (Z) fulfil the following features:
   a) their median diameter x50 is in the range of 30-200 μm;
   b) they are predominately rounded, and characterized in that the width/length ratio (aspect ratio w/l) is at least 0.76;
   c) their distribution range SPAN ((x90−x10)/x50) is at least 0.28.

In the context of this invention, the terms “heat-conducting” and “thermally conductive” are equivalent.

Thermally conductive fillers (Z) in the context of this invention are understood to mean any fillers having a thermal conductivity of at least 5 W/mK.

Heat-conducting silicone composition (Y) in the context of this invention is understood to mean those silicone compositions that distinctly surpass the thermal conductivity of a filler- and additive-free polydimethylsiloxane, typically about 0.2 W/mK, characterized in that they have a thermal conductivity of at least 0.6 W/mK.

In the context of this invention, all parameters that describe particle size (parameter: median diameter x50), particle size distribution (parameters: standard deviation sigma and distribution range SPAN) or particle shape (parameters: aspect ratio w/l and sphericity SPHT) are based on a volume-based distribution. The indices mentioned may be determined, for example, by means of dynamic image analysis according to ISO 13322-2 and ISO 9276-6, for example with a Camsizer X2 from Retsch Technology.

The person skilled in the art is aware that standard deviation is not standardized and is a viable characteristic for assessment of particle size distribution of different samples only when the average particle sizes of the comparative samples are about the same. For description of the relative breadth of the particle size distribution in the context of this invention, therefore, the particle size distribution range weighted by the median particle size x50 is used, the dimensionless distribution range SPAN defined as:

SPAN=(x90−x10)/x50.

Aspect ratio serves as an index for description of the particle shape. The earlier prior art frequently describes the aspect ratio in terms of the ratio of length to width (l/w). This results in values of not less than 1. In the more recent literature, for example according to ISO 9276-6, the aspect ratio is calculated from the reciprocal ratio of width to length (w/l). This results in values of not more than 1. The two indices can be interconverted by forming the reciprocal. In the context of this invention, aspect ratio is defined as the ratio of width to length (w/l) of the particle. Particle width is given here by x_{c min}, the smallest of all the maximum chords measured in the particle projection, and particle length is given by x_{Fe max}, the longest Feret diameter of all Feret diameters measured in a particle. More detailed information can be found, for example, in “Operating Instructions/Manual Particle Size Analysis System CAMSIZER®”, Retsch Technology GmbH, 42781 Haan; Doc. No. CAMSIZER V0115. This results in the following formula for aspect ratio:

w/l=x_{c min}/x_{Fe max}

Sphericity SPHT is calculated from the projection area A of the particle being analysed relative to the area of a circle having the same circumference P of the projected particle according to the following formula (more detailed information can be found, for example, in “Operating Instructions/Manual Particle Size Analysis System CAMSIZER®”, Retsch Technology GmbH, 42781 Haan; Doc. No. CAMSIZER V0115):

SPHT=4πA/P²

The index SPHT corresponds to the square of the circularity C according to ISO 9276-6.

In order not to create an excessive number of pages in the description of the present invention, only the preferred embodiments of the individual features are detail hereinafter.

However, the expert reader will explicitly understand this manner of disclosure such that any combination of different levels of preference is thus also explicitly disclosed and explicitly desired.

### Non-Crosslinkable Silicone Composition (S)

Non-crosslinkable silicone composition (S) contain:
one or a mixture of at least two organopolysiloxanes (T) having the following properties:
   they are linear, branched or cyclic, preferably linear
   end-capped at both ends or singly Si—OH terminated or singly alkoxy-silyl terminated, preferably end-capped at both ends,
   the Si-bonded side and end groups R¹ are independently substituted or unsubstituted C1 to C18 hydrocarbon groups, preferably C1-C10 monovalent hydrocarbon groups. Examples of R¹ include linear, branched and cyclic alkyl, alkenyl, aryl, aralkyl and haloalkyl groups. Suitable pure alkyl groups include the methyl, ethyl, propyl, hexyl and octyl groups. Suitable branched alkyl groups include isopropyl, isobutyl, tert-butyl and 2-ethylhexyl groups. Suitable cyclic alkyl groups include cyclopentyl and cyclohexyl groups. Suitable alkenyl groups are vinyl and allyl groups. Suitable aryl groups include phenyl and tolyl groups. Suitable aralkyl groups include 2-phenylethyl and 2-methyl-2-phenylethyl groups. Suitable haloalkyl groups include 3,3,3-trifluoropropyl, 2-(nonafluorobutyl)ethyl and 2-(heptadecafluorooctyl)ethyl groups. Preferred R¹ are the methyl or phenyl groups.

The process for preparing end-capped organopolysiloxanes has long been known to the person skilled in the art and proceeds, for example, from dichloromethylsilane in the presence of water to give linear end-capped polymethylpolysiloxanes.

The dynamic viscosity of these organopolysiloxanes (T) is between 35 and 1 000 000 mPas, preferably 50-100 000 mPas, at 25° C. They have long been known in the prior art and are frequently referred to as silicone oils.

In order to adjust the stability under load or rheology of the non-crosslinkable silicone composition (S), it is possible to add what are called rheology additives (E) (=structure formers). These are known to the person skilled in the art from the prior art.

Suitable rheology additives (E) are solid finely divided inorganic fillers. Suitable examples are reinforcing and non-reinforcing fillers such as metal oxides or furnace black and acetylene black.

Examples of suitable reinforcing fillers (E), i.e. fillers having a BET surface area of at least 50 m²/g, are fumed silica, precipitated silica or mixed silicon-aluminium oxides having a BET surface area of more than 50 m²/g. The fillers mentioned may have been hydrophobized, for example by treatment with organosilanes, -silazanes or -siloxanes or by etherification of hydroxyl groups to alkoxy groups. As a result of a surface treatment, such silicas have a carbon content of at least 0.01% to at most 20% by weight, preferably between 0.1% and 10% by weight, more preferably between 0.5% and 6% by weight.

Examples of suitable non-reinforcing fillers (E), i.e. fillers having a BET surface area of less than 50 m²/g, are powders of quartz, cristobalite, diatomaceous earth, calcium silicate, zirconium silicate, montmorillonites, such as bentonites, zeolites including the molecular sieves, such as sodium aluminium silicate, metal oxides such as aluminium oxide or zinc oxide or the mixed oxides thereof, metal hydroxides such as aluminium hydroxide, barium sulfate, calcium carbonate, gypsum, silicon nitride, silicon carbide, boron nitride, glass powder, carbon powder and polymer powder, and hollow glass and plastic beads. The BET surface area of the non-reinforcing fillers is preferably less than 20 m²/g.

Additionally suitable as rheology additives (E) are crosslinked hydrosilylation reaction products obtainable from the reaction of
at least one alkenyl-terminated polydiorganosiloxane having a degree of polymerization of at least 300 and
at least one organohydrosiloxane crosslinker having an average of 2 or more SiH groups per molecule,
where the ratio of the alkenyl-terminated polydiorganosiloxane and the organohydrosiloxane is adjusted such that the molar ratio of SiH groups to alkenyl groups is within a range from 0.5 to 2.0.

Crosslinking of this type of rheology additives (E) is known to the person skilled in the art from the prior art and may precede the addition to the abovementioned non-crosslinkable silicone compositions (S), or else the structure former is crosslinked in situ in the abovementioned non-crosslinkable silicone compositions (S).

Additionally suitable as rheology additives (E) are also non-particulate organic rheology additives, or those based on organic polymers. These are commercially available. BASF sells such rheology additives, for example, under the following trade names: RHEOVIS®, ATTAGEL®, ATTAFLOW® and EFKA®. Further suitable rheology additives are sold by CRODA under the Atlox Rheostrux™ 100 (a polyester block copolymer) or Atlox Rheostrux™ 200 (a polyamide) trade names.

It is possible to use one type of rheology additive (E), or else a mixture of at least two rheology additives.

If rheology additive (E) are present, they are preferably present to an extent of 1-9% by weight, preferably 2-8% by weight, based on the total mass of silicone composition (S).

The non-crosslinkable silicone composition (S) according to the invention may contain alkyltrialkoxysilanes (F) as further additions in order to reduce the viscosity thereof. If they are present, they are preferably present to an extent of 0.1-8% by weight, preferably 0.2-6% by weight, based on the total mass of silicone composition (S), where the alkyl group may be a saturated or unsaturated, linear or branched alkyl group having 2 to 20, preferably 8-18, carbon atoms, and the alkoxy groups may have 1 to 5 carbon atoms. Examples of the alkoxy groups include methoxy groups, ethoxy groups, propoxy groups and butoxy groups, particular preference being given to methoxy groups and ethoxy groups. Especially preferred for (F) is n-octyltrimethoxysilane, n-dodecyltrimethoxysilane, n-hexadecyl-trimethoxysilane and n-octadecyltrimethoxysilane.

The non-crosslinkable silicone compositions (S) according to the invention may optionally further constituents (G). These optional additives are resinous polyorganosiloxanes, fungicides, fragrances, corrosion inhibitors, oxidation inhibitors, light stabilizers, flame retardants and compositions for influencing electrical properties, dispersing aids, solvents, pigments, dyes, organic polymers, heat stabilizers etc.

### Thermally Conductive Filler (Z)

The non-crosslinkable heat-conducting silicone composition (Y) according to the invention contains at least one thermally conductive filler (Z) having a thermal conductivity of at least 5 W/mK, with the proviso that the non-crosslinkable heat-conducting silicone compositions (Y) according to the invention contain at least 20% by volume of metallic silicon particles as thermally conductive fillers (Z) that still have to fulfil at least the further specific features a) to c) and in a preferred embodiment also d), and the total amount of thermally conductive fillers (Z) is at least 50% by volume.
a) The median diameter x50 of these metallic silicon particles (Z) according to the invention is in the range of 30-200 μm, preferably in the range of 40-180 μm, more preferably in the range of 50-160 μm.
b) The metallic silicon particles (Z) according to the invention are predominantly rounded and are preferably produced by a melting method. The predominantly rounded shape of the particles according to the invention is characterized in that the width/length ratio (aspect ratio w/l) is at least 0.76, preferably at least 0.77, more preferably at least 0.78, especially at least 0.79.

The silicon particles (Z) according to the invention preferably have a sphericity value SPHT of at least 0.75, preferably at least 0.76, more preferably at least 0.78, especially preferably of at least 0.79.

In an especially preferred embodiment, the silicon particles (Z) according to the invention have an aspect ratio of at least 0.76 and simultaneously a sphericity value SPHT of at least 0.75, preferably at least 0.76, more preferably at least 0.78, especially preferably of at least 0.79.
c) The distribution range of the particle size (SPAN) is defined as SPAN=(x90−x10)/x50. The SPAN of the metallic silicon particles (Z) according to the invention is at least 0.28, preferably at least 0.30, more preferably at least 0.35, especially preferably at least 0.38. In a preferred embodiment, the SPAN is between 0.40 and 2.5, preferably between 0.41 and 2.2, especially between 0.5 and 2.0.

It is immaterial here whether a single fraction of silicon particles (Z) having a SPAN within the range according to the invention is used, or whether two or more fractions of silicon particles are mixed and hence the inventive particle size distribution range according to feature c) of the inventive silicon particles (Z) is achieved. If two or more fractions of silicon particles are mixed, this may precede the mixing with one or more components of the composition according to the invention, or the fractions of silicon particles may also be mixed separately from one another with one or more components of the composition according to the invention. The sequence of addition here does not matter.

Preferably not more than four fractions of silicon particles are mixed so as to achieve the distribution range according to the invention, preferably not more than three fractions of silicon particles are mixed so as to achieve the distribution range according to the invention, more preferably not more than two fractions of silicon particles according to the invention are used so as to achieve the distribution range according to the invention, and especially preferably just a single silicon powder according to the invention is used.

d) The inventive silicon particles (Z) contain, in a preferred embodiment, not more than 1.5% by weight of silicon particles smaller than 2 μm, preferably not more than 1% by weight, more preferably not more than 0.5% by weight, based in each case on the total amount of silicon particles (Z). Especially preferred silicon particles (Z) are essentially free of particle fractions smaller than 2 μm. What is meant by “essentially free of” is that the presence of such particles is tolerated within the scope of an “impurity” in the inventive particles (Z) and does not affect the inventive action thereof.

The inventive silicon particles (Z) contain preferably less than 20% by weight, more preferably less than 15% by weight, especially preferably less than 10% by weight, of a particle fraction having a diameter of not more than 20 μm, based in each case on the total amount of silicon particles.

The inventive silicon particles (Z) contain preferably less than 15% by weight, more preferably less than 10% by weight, especially preferably less than 5% by weight, of a particle fraction having a diameter of not more than 10 μm, based in each case on the total amount of silicon particles.

In an especially preferred embodiment, there is no intentional addition of silicon particles having an average diameter of not more than 10 μm. Preference is given to adding no silicon particles that are not larger than 15 μm. There is especially preferably no intentional addition of silicon particles having an average diameter of not more than 20 μm.

It is also a disadvantage of very fine silicon particles or ground silicon particles that such particles have a comparatively large surface area and bind a very large amount of polymer. This increases the viscosity of the silicone composition very significantly, such that it is only possible to produce mixtures having comparatively low filler levels and hence low thermal conductivity. In the case of higher filler levels, the composition becomes very stiff and can no longer be processed by conventional methods, for example dispensers. It is also found that silicone compositions containing ground silicon particles are comparatively highly combustible.

Metallic silicon has multiple very advantageous properties for use as a thermally conductive filler (Z). For example, the exceptionally high thermal conductivity of silicon particles (Z) improves the thermal conductivity of the thermally conductive silicone composition (Y) produced therefrom. The low density of the silicon particles (Z) reduces the weight of the composition and of the components produced therefrom and helps to save costs. The low electrical conductivity enables the production of electrically insulating components and improves electrical breakdown resistance. The low Mohs hardness of the silicon particles (Z) reduces abrasion in the course of processing. It will be clear to the person skilled in the art that the advantages mentioned are wholly or partly lost with decreasing purity of the silicon. The purity of the silicon particles (Z) according to the invention and hence the silicon content is at least 80%, preferably at least 90%, more preferably at least 95%.

It is also apparent to the person skilled in the art that metallic silicon particles are combustible under particular conditions and the dusts present an explosion risk. The person skilled in the art is also aware that the risk of dust formation, combustibility and explosion risk associated with metal powders increases significantly with decreasing particle size. For that reason, very small silicon particles below 30 μm are unsuitable for many applications. Such particles, on account of the low minimum ignition energy, are hazardous to handle and require complex and costly safety precautions in industrial processing. It has also been found that compositions containing very small silicon particles below 30 μm and are comparatively highly combustible.

Larger silicon particles having an average particle size exceeding 30 μm have a comparatively high minimum ignition energy and are therefore more safely and easily processible in industrial processes. Nevertheless, compositions containing noninventive ground, angular silicon particles larger than 30 μm were found to be comparatively highly combustible. Silicon particles having an average particle size exceeding 200 μm are unsuitable for many applications of heat-conducting silicone compositions since such large-grain silicon particles frequently do not fit into the fine gaps that have to be filled with gap fillers, for example. Moreover, it is found that such large-grain silicon particles also show comparatively high combustibility.

The use of spherical fillers for improving flowability and processibility of filled polymers is sufficiently well known in the prior art. However, there are only a few prior art documents in which spherical silicon particles are used in thermally conductive silicone compositions. The compositions disclosed contain exclusively very small spherical silicon particles having an average particle size of less than 25 μm, the disadvantages of which have been described.

It has been found, completely surprisingly, that the non-crosslinkable, heat-conducting silicone compositions (Y) according to the invention are thermally conductive and simultaneously of low combustibility when they contain metallic silicon particles according to the invention that simultaneously fulfil features a) to c), in the required minimum amounts.

The non-crosslinkable silicone composition (Y) according to the invention contains at least 20% by volume of such metallic silicon particles (Z), preferably at least 25% by volume, more preferably at least 30% by volume, especially preferably at least 35% by volume. If the silicone composition (Y) contains smaller amounts of metallic silicon particles (Z), the desired advantageous effects of the metallic silicon, for example the low density and high thermal conductivity, are no longer sufficiently provided.

The prior art includes various methods of producing finely divided metal particles with a rounded shape. The silicon particles (Z) according to the invention are preferably produced from a molten state, as a result of which they have a comparatively smooth surface and are essentially free of fractures, sharp edges and pointed corners. In this way, they differ from conventional ground particles that have been converted to the final form, for example, by means of crushing, grinding or milling. It is immaterial here whether the particles are comminuted cold in a first process step, for example by grinding, and then converted to a molten form by heating above the melting point, for example by heat treatment in a hot zone, for example by means of a plasma, or whether a silicon melt is first produced and then comminuted, for example by atomizing. The silicon particles according to the invention are preferably converted to the solid form according to the invention by spraying or atomizing of a silicon melt, followed by cooling.

Suitable methods of producing the silicon particles (Z) according to the invention are known to the person skilled in the art and are described, for example, in chapter 2.2 in “Pulvermetallurgie: Technologien and Werkstoffe [Powder Metallurgy: Technologies and Materials], Schatt, Werner, Wieters, Klaus-Peter, Kieback, Bernd, p. 5-48, ISBN 978-3-540-681112-0, E-Book: https://doi.org/10.1007/978-3-540-68112-0_2”. Preferred processes for producing the silicon particles (Z) according to the invention are inert gas atomization, also called gas atomization, pressurized water atomization, also called liquid atomization or water atomization methods, or melt spinning methods, also called centrifugal atomization or rotary atomization.

The processes described permit the production of metallic silicon particles in a very different particle size range, especially in the average particle size range from a few micrometres to a few millimetres. It is also possible for the metallic silicon particles to be produced in very different grain form, for example “spattered”, i.e. very irregularly, ellipsoidally or spherically, and with a very variable range of particle size distribution. Completely surprisingly, it has been found that advantageous properties according to the invention, especially comparatively low combustibility, are exhibited exclusively by those silicon particles that are predominantly rounded and simultaneously fulfil the inventive features a) to c).

The production process for the metallic silicon particles (Z) according to the invention should preferably be executed in such a way that the particles are obtained in their predominantly rounded form according to the invention and hence fulfil features a)-c) and are essentially free of spattered, nodular, angular or sharp particles. The solidified particles may be separated by size in a subsequent process step by standard methods, for example by means of classifying by sieving or by means of sifting. In these methods, it is possible to separate agglomerates and bonded particles, but essentially no particles are destroyed. What is meant by “predominantly rounded” and “essentially free of” is that the presence of such particles is tolerated within the scope of an “impurity” in the particles (Z) according to the invention and does not disrupt their inventive effect.

The non-crosslinkable silicone composition (Y) according to the invention may, as well as these metallic silicon particles (Z), contain further thermally conductive fillers (Z) having thermal conductivity greater than 5 W/mK. Examples of such further thermally conductive fillers (Z) are magnesium oxide, metallic aluminium powder, metallic silver powder, zinc oxide, boron nitride, silicon carbide, aluminium nitride, aluminium hydroxide, aluminium oxide, graphite, and so forth. Preferred further fillers are aluminium powder, magnesium oxide, aluminium hydroxide, zinc oxide and aluminium oxide. Particularly preferred fillers are aluminium hydroxide and aluminium oxide, with aluminium hydroxide being especially preferred. The shape of the further filler is fundamentally unrestricted. The particles may, for example, be of spherical, ellipsoidal, acicular, tubular, platelet, fibrous or irregular shape. They are preferably of spherical, ellipsoidal or irregular shape. The average diameter of the further thermally conductive fillers (Z) is preferably in the range of 0.01-200 μm, preferably in the range of 0.1-150 μm, more preferably in the range of 0.2-120 μm, especially in the range of 0.4-80 μm.

Fillers having very high density are disadvantageous in use, for example in aircraft and electrical vehicles, since they very significantly increase the weight of the components. The further thermally conductive fillers (Z) preferably have a density of not more than 6.0 g/cm³, preferably not more than 4.5 g/cm³, more preferably not more than 3.0 g/cm³.

The inventive non-crosslinkable silicone composition (Y) preferably contains not more than 24% by weight, preferably not more than 20% by weight, more preferably not more than 16% by weight, especially preferably not more than 12% by weight, of a further heat-conducting filler (Z) having a density of greater than 5.0 g/cm³. In an especially preferred embodiment, the inventive non-crosslinkable silicone composition (Y) is free of further heat-conducting fillers (Z) having a density of greater than 5.0 g/cm³.

Preferably, the inventive non-crosslinkable silicone composition (Y) contains not more than 60% by weight, preferably not more than 45% by weight, more preferably not more than 30% by weight, especially preferably not more than 20% by weight, of a further heat-conducting filler (Z) having a density of greater than 3.0 g/cm³.

In many applications, electrical conductivity of the heat-conducting composition is undesirable since this can lead to short circuits, for example. The composition (Y) according to the invention preferably contains exclusively heat-conducting fillers (Z) having specific resistivity of at least 1 Ω·mm²/m.

Preferred non-crosslinkable, heat-conducting silicone compositions (Y) according to the invention contain, as thermally conductive filler (Z), the metallic silicon particles according to the invention as the sole thermally conductive filler (Z) or in combination with up to three further thermally conductive fillers (Z). Impurities of up to 5% are not considered here to be a further filler (Z).

If the preferred compositions according to the invention contain the metallic silicon particles (Z) according to the invention as the sole thermally conductive filler (Z) having a thermal conductivity greater than 5 W/mK, preference is given to adding a rheology modifier or thickener that prevents the settling of the filler. Suitable rheology modifiers are known to the person skilled in the art, preference being given to fumed silica.

The total amount of thermally conductive fillers (Z) in the non-crosslinkable heat-conducting silicone composition (Y) according to the invention is 50-95% by volume, preferably 60-90% by volume, more preferably 65-88% by volume. If the silicone composition (Y) contains smaller amounts of heat-conducting filler (Z), thermal conductivity will be inadequate; if the silicone composition (Y) contains greater amounts of thermally conductive filler (Z), then the composition (Y) will be difficult to process since it will have high viscosity or even be brittle.

The non-crosslinkable, heat-conducting silicone compositions (Y) according to the invention have a thermal conductivity of at least 0.6 W/mK, preferably at least 0.8 W/mK, more preferably at least 1.2 W/mK, especially at least 1.5 W/mK.

The viscosity of the non-crosslinkable, thermally conductive silicone compositions (Y) according to the invention may vary within a very wide range and be matched to the requirements of the application. The viscosity of the non-crosslinkable, thermally conductive silicone compositions (Y) according to the invention is preferably adjusted via the content of thermally conductive filler (Z) and/or the composition of the silicone composition (S), by the standard methods from the prior art. These are known to the person skilled in the art. Preference is given to adjusting the viscosity via the selection and combination of components (T) and (Z) and the optional addition of (E) and/or (F).

The dynamic viscosity of the thermally conductive non-crosslinkable silicone compositions (Y) according to the invention is preferably in the range of 100-1 000 000 mPa·s, preferably in the range of 1000-750 000 mPa·s, more preferably in the range of 2000-500 000 mPa·s, especially not more than 250 000 mPa·s, in each case at shear rate D=10 s⁻¹ and 25° C.

The density of the thermally conductive, non-crosslinkable silicone compositions (Y) according to the invention is less than 4.5 g/cm³, preferably less than 4.0 g/cm³, more preferably less than 3.5 g/cm³, especially less than 3.3 g/cm³.

The present invention further provides a process for producing the non-crosslinkable, thermally conductive silicone compositions (Y) according to the invention by mixing the individual components.

The components may be mixed by the customary continuous and batchwise prior art methods. Suitable mixing apparatus is any of the known apparatuses. Examples of these are uniaxial or biaxial continuous mixers, twin rollers, Ross mixers, Hobart mixers, dental mixers, planetary mixers, kneaders and Henschel mixers or similar mixers. Preference is given to mixing in a planetary mixer, a kneader or a continuous mixer. The non-crosslinkable silicone composition (Y) may optionally be heated in the course of mixing, preference being given to mixing within a temperature range of 15-140° C., preferably within a range of 15-60° C. The procedure for production of the preferred non-crosslinkable silicone compositions (Y) is also known to the person skilled in the art. In principle, the components may be added in any sequence. For example, components e) and optionally g) may be premixed and then mixed with components a) and/or b). It is optionally also possible here to heat the mixture. Preference is given to mixing at least a portion of a) and the alkoxysilane g), then mixing in the heat-conducting filler(s) (Z). The production preferably takes place without active heating.

The non-crosslinkable silicone composition (Y) according to the invention has very good processing properties with regard to fluidity, gap-filling properties and layer thickness control, and can be applied precisely.

The present invention further provides for the use of the non-crosslinkable, heat-conducting silicone composition (Y) as thermal paste for dissipation of heat from heat generators in electronic apparatuses. The non-crosslinkable, heat-conducting silicone composition (Y) is applied to heat generators or heat dissipators, or they are coated therewith. Heat generators are encountered in electronic apparatuses of power supplies and in electronic devices, for example supply transistors, power modules, transistors, thermocouples and temperature sensors; heat-generating electronic components, for example parts of integrated circuits such as CPUs and batteries. Suitable heat dissipators include heat-dissipating components such as heat distributors and heat sinks and cooling lamellas. If the non-crosslinkable, heat-conducting silicone composition (Y) is introduced between a heat generator and a heat dissipator, the heat can be guided efficiently from the heat generator to the heat dissipator. This achieves an effective cooling effect on the heat generator.

### Test Methods

### Measurement of Thermal Conductivity Lambda

Thermal conductivity is determined to ASTM D5470-12 using a TIM Tester (Steinbeis Transferzentrum Wärmemanagement in der Elektronik, Lindenstr. 13/1, 72141 Walddorfhäslach, Germany). This determines the thermal resistance of the sample between 2 test cylinders by means of a constant heat flow. The layer thickness of the sample is used to calculate the effective thermal conductivity.

For the measurement, the sample is applied with the aid of a stencil and the measuring cylinder is narrowed manually to a thickness of 1.9-2.0 mm, then excess material is removed. Thermal conductivity is measured at a constant gap of 1.8-1.6-1.4-1.2-1.0 mm. Evaluation is effected by means of an integrated reporter position. After a plausibility test (straight-line coefficient of determination >0.998), the thermal conductivity lambda is reported as the effective thermal conductivity in W/(m*K).

### Measurement of Dynamic Viscosity

Dynamic viscosity was measured using an Anton Paar MCR 302 rheometer according to DIN EN ISO 3219:1994 and DIN 53019 by means of a flow curve with the following parameters: measurement type: T/D; temperature: 25.0° C.; measuring element: PP25; measurement gap: 0.50 mm; shear rate: 0.1-10 s⁻¹; time: 120 sec; measurements: 30. The viscosity reported in Pa·s is an interpolated value at a shear rate of D=10 s⁻¹.

### Measurement of Density

The density of the uncrosslinked, thermally conductive silicone compositions was ascertained according to ISO 1183, and the density of the crosslinked, thermally conductive silicone compositions according to ISO 1184.

### Particle Size and Particle Shape Analysis

Particle size (median diameter x50), particle size distribution (parameters: standard deviation sigma and distribution range SPAN) and particle shape (parameters: aspect ratio w/l and sphericity SPHT) were analysed with a Camsizer X2 from Retsch Technology (measurement principle: dynamic image analysis) according to ISO 13322-2 and ISO 9276-6 (method of analysis: dry measurement of powders and granules; measurement range: 0.8 μm-30 mm; compressed air dispersion with “X-Jet”; dispersion pressure=0.3 bar). Evaluations were volume-based and by the x_{c min} model.

The examples which follow describe the basic implementability of the present invention, but without limiting it to the contents disclosed therein.

In the examples which follow, all figures for parts and percentages, unless stated otherwise, are based on weight. Unless stated otherwise, the examples which follow are conducted at a pressure of the surrounding atmosphere, i.e. at about 1000 hPa, and at room temperature, i.e. about 20° C. or a temperature which is established on combination of the reactants at room temperature without additional heating or cooling.

### EXAMPLES

### Overview of the Inventive and Noninventive Silicon Powders and Silicon Powder Mixtures Used

Table 1 summarizes the properties of the inventive and noninventive silicon powders used in the examples.

Inventive examples 1-3 using inventive silicon powders that have been obtained by means of inert gas atomization, and hence are predominantly rounded, and additionally have a comparatively broad particle size distribution according to the invention.

Noninventive comparative examples V1-V2 use noninventive silicon powders that have been obtained by means of inert gas atomization, and hence are predominantly rounded, but have a comparatively narrow, noninventive particle size distribution and do not fulfil inventive feature c).

Noninventive comparative examples V3-V5 use noninventive silicon powders having a comparatively broad particle size distribution, but have been obtained by means of grinding methods, and hence are essentially angular with sharp edges and do not fulfil inventive feature b). Comparative examples V5 has a content of silicon particles smaller than 2 μm of 3.8% by weight and hence additionally does not fulfil feature d).

### Example 4: Production of Silicon Powder Mixture 4 (Inventive)

100 g of a noninventive silicon powder having an x50 of 68.6 μm, a SPAN of 0.20, a w/l of 0.85 and SPHT of 0.84, 200 g of the noninventive silicon powder from comparative example V2, 400 g of a noninventive silicon powder having an x50 of 105.4 μm, a SPAN of 0.24, a w/l of 0.83 and SPHT of 0.92, 200 g of a noninventive silicon powder having an x50 of 133.8 μm, a SPAN of 0.25, a w/l of 0.82 and SPHT of 0.94, and 100 g of a noninventive silicon powder having an x50 of 162.1 μm, a SPAN of 0.22, a w/l of 0.82 and SPHT of 0.94 are mixed homogeneously with a commercial RW 28 laboratory stirrer system (IKA®-Werke GmbH & CO. KG, 79219 Staufen, Germany). What is obtained is an inventive silicon powder mixture having an x50 of 107.8 μm, a SPAN of 0.75, a w/l of 0.83 and SPHT of 0.91, and fulfilling inventive features a) to c) and even d).

### Abbreviations

Ex. example
V comparative example
PS particle shape
r predominantly rounded
e angular
n nodular
I inventive
NI noninventive
n.d. not determined

TABLE 1
Overview of the silicon powders used

| | | x50 | | | | | | |
|---|---|---|---|---|---|---|---|---|
| | x10 | (mm) | x90 | SPAN | | PS | w/l | |
| Ex. | (mm) | Feature a) | (mm) | Feature c) | SPHT | Feature b) | | Comment |
| 1* | 23.4 | 58.9 | 123.3 | 1.69 | 0.82 | r | 0.85 | I |
| 2* | 55.7 | 82.9 | 125.8 | 0.85 | 0.86 | r | 0.83 | I |
| 3* | 126.3 | 155.1 | 180.1 | 0.41 | 0.94 | r | 0.82 | I |
| 4* | 72.5 | 107.8 | 152.9 | 0.75 | 0.91 | r | 0.83 | I |
| V1 | 48.9 | 52.1 | 58.5 | 0.18 | 0.82 | r | 0.85 | NI |
| V2 | 72.6 | 82.1 | 92.2 | 0.24 | 0.89 | r | 0.83 | NI |
| V3 | 10.8 | 36.9 | 84.9 | 2.01 | 0.76 | e | 0.67 | NI |
| V4 | 20.1 | 95.3 | 187.5 | 1.76 | 0.78 | e | 0.63 | NI |
| V5** | 3.1 | 5.9 | 8.8 | 0.97 | 0.86 | e | 0.75 | NI |

*The content of silicon particles <2 μm within the scope of measurement accuracy was 0.0% by weight.
**The content of silicon particles <2 μm was 3.8% by weight.

### General Method 1 (GM1) for Production of the Non-Crosslinkable, Thermally Conductive, Silicon Powder-Containing Silicone Composition (Inventive Examples 5 to 8 and Noninventive Examples V6 to V12)

### Step 1: Preparation of a Non-Crosslinkable, Thermally Conductive, Silicon Powder-Containing Silicone Composition

40.8 g of a trimethylsiloxy-terminated polydimethylsiloxane having a viscosity of 1000 mPa·s and 5.18 g of a trimethylsiloxy-terminated polydimethylsiloxane having a viscosity of 200 mPa·s and a content of Si-bonded hydrogen of 0.18% by weight,
were homogenized by means of a SpeedMixer DAC 400 FVZ (Hauschild & Co KG, Waterkamp 1, 59075 Hamm, Germany) at a speed of 2350 rpm for 25 seconds. Thereafter, a silicon powder was added in each case in the ratio according to table 2 or according to table 3 and mixed by means of a SpeedMixer at 2350 rpm for 25 seconds. The silicon particle-containing silicone composition was stirred with a spatula to mix in silicon powder residues from the edge of the vessel. This was followed by homogenization at 2350 rpm by SpeedMixer for a further 25 seconds and cooling to room temperature.

A pasty mass is obtained.

### Example 9 Combustibility Testing

The combustibility of the inventive non-crosslinkable silicone composition according to example 5 and the noninventive silicone compositions according to comparative examples V6 to V8 is tested in a simplified test based on UL 94 HB.

The inventive non-crosslinkable silicone compositions according to example 5 and the noninventive silicone compositions according to comparative examples V6 to V8 are applied in a layer of thickness 2 mm to an aluminium plate of length 150 mm, width 10 mm and thickness 2 mm. The plate is secured in a vertical position along the long right-hand side such that the aluminium backing faces backward and the knife-coated sample forward. The burner is adjusted so as to give a blue flame of length 325 mm. The flame is directed onto the front face of the specimen in a horizontal position, at right angles to the test piece, such that the tip of the blue flame points toward the front face of the test piece 20 mm from the left-hand end of the test piece. After being in contact for 30 seconds, the flame is removed.

Testing and assessment of combustibility: during flame application, the appearance of the flame and possible dripping of burning sample material is observed. The afterflame time (total afterburn and afterglow time) of the test piece is noted. The sample should show a weak flame appearance during flame application and should not give off burning drops. After the flame has been removed, the sample should be extinguished immediately and show afterburn or glow for less than 1 second. The test is conducted on 3 different test pieces, and the average value of the afterflame time is ascertained. The results can be found in table 2.

In noninventive comparative experiment V7, containing 62.5% by volume of the noninventive silicon particles according to comparative example V5, which more particularly do not fulfil feature b), a silicone composition of very high viscosity was formed, which could not be applied and tested in a uniform layer.

TABLE 2
Composition and combustibility of silicon powder-containing silicone compositions

| | | | | Non-crosslinkable | |
|---|---|---|---|---|---|
| | | | | silicone composition | |
| | Silicon powder according to table 1 | | | | Thermal |
| | | Amount | Content | Density | conductivity |
| Ex. | Ex. | (g) | (% by vol.) | (g/cm³) | (W/mK) |
| 5 | 1 | 184.0 | 62.5 | 1.82 | 1.9 |
| V6 | V1 | 184.0 | 62.5 | 1.82 | 1.8 |
| V7 | V5 | 184.0 | 62.5 | 1.82 | 1.8 |
| V8 | V5 | 144.8 | 49.2 | 1.64 | 1.2 |

| | Silicon powder according to table 1 | | |
|---|---|---|---|
| | Flame | Afterflame time | |
| Ex. | appearance | (s) | Burning drops |
| 5 | weak | <1 | no |
| V6 | intense | <1 | yes |
| V7 | n.d. | n.d. | n.d. |
| V8 | intense | 8 | no |

In the testing of combustibility, it was found that comparative examples V6 and V8, containing a noninventive silicon powder according to comparative examples V1 or V5 which does not fulfil one or more of features a) to d), show comparatively unfavourable fire performance.

Entirely unexpectedly, it was found that the inventive silicon powder from example 1, which simultaneously fulfils features a) to c) and even d), shows the inventive advantage of reduced combustibility.

### Example 10 Combustibility Testing

The combustibility of the inventive non-crosslinkable silicone compositions according to examples 6 to 8 and of the noninventive silicone compositions according to comparative examples V9 to V12 is tested in a simplified test based on UL 94 HB. By contrast with example 9, the plates were secured in a horizontal position, such that the aluminium backing faces downward and the knife-coated sample upward.

In the case of the noninventive comparative experiment V10, containing 62.5% by volume of the noninventive silicon particles according to comparative example V3, which more particularly do not fulfil feature b), the result was a silicone composition of very high viscosity that could not be applied and tested in a uniform layer.

Testing and assessment of combustibility: during flame application, the appearance of the flame and possible dripping of burning sample material is observed. The afterflame time (total afterburn and afterglow time) of the test piece is noted. The sample should show a weak flame appearance during flame application and should not give off burning drops. After the flame has been removed, the sample should be extinguished immediately and show afterburn or glow for less than 1 second. The test is conducted on 3 different test pieces, and the average value of the afterflame time is ascertained. The results can be found in table 3.

TABLE 3
Composition and combustibility of silicon powder-containing silicone compositions

| | | | | Non-crosslinkable | |
|---|---|---|---|---|---|
| | | | | silicone composition | |
| | Silicon powder according to table 1 | | | | Thermal |
| | | Amount | Content | Density | conductivity |
| Ex. | Ex. | (g) | (% by vol.) | (g/cm³) | (W/mK) |
| 6 | 2 | 184.0 | 62.5 | 1.82 | 1.9 |
| 7 | 3 | 184.0 | 62.5 | 1.82 | 1.8 |
| 8 | 4 | 184.0 | 62.5 | 1.82 | 2.0 |
| V9 | V2 | 184.0 | 62.5 | 1.82 | 1.9 |
| V10 | V3 | 184.0 | 62.5 | 1.82 | 1.8 |
| V11 | V4 | 184.0 | 62.5 | 1.82 | 1.9 |
| V12 | V3 | 144.8 | 49.2 | 1.64 | 1.1 |

| | Fire performance | | |
|---|---|---|---|
| | Flame | Afterflame time | |
| Ex. | appearance | (s) | no |
| 6 | weak | 0 | no |
| 7 | weak | 1 | no |
| 8 | weak | 0 | yes |
| V9 | weak | 5 | n.d. |
| V10 | n.d. | n.d. | no |
| V11 | weak | 9 | no |
| V12 | intense | 17 | no |

It was found that the inventive non-crosslinkable silicone compositions according to examples 6 to 8, which contain inventive silicon powders from examples 2 to 4 that simultaneously fulfil features a) to c) and even d), show the inventive advantage of reduced combustibility.

In inventive example 8, moreover, it was found, completely surprisingly, that mixing of multiple noninventive silicon powders can produce an inventive silicon powder mixture according to example 4 having the advantageous property according to the invention of low combustibility, provided that the resultant mixture fulfils features a) to c) and even d).

### Example 11 Production of a Non-Crosslinkable, Thermally Conductive Silicone Composition Containing an In Situ Mixture of Silicon Powders (Inventive)

According to general method GM1, an inventive non-crosslinkable thermally conductive silicone composition was produced by separately adding, as silicon powder, 18.4 g of a noninventive silicon powder having an x50 of 68.6 μm, a SPAN of 0.20, a w/l of 0.85 and SPHT of 0.84, 36.8 g of a noninventive silicon powder from comparative example V2, 73.6 g of a noninventive silicon powder having an x50 of 105.4 μm, a SPAN of 0.24, a w/l of 0.83 and SPHT of 0.92, 36.8 g of a noninventive silicon powder having an x50 of 133.8 μm, a SPAN of 0.25, a w/l of 0.82 and SPHT of 0.94, and 18.4 g of a noninventive silicon powder having an x50 of 162.1 μm, a SPAN of 0.22, a w/l of 0.82 and SPHT of 0.94 and mixing them in situ to form an inventive silicon powder mixture.

What was obtained was an inventive non-crosslinkable silicone composition having a content of inventive silicon particles of 62.5% by volume. The thermal conductivity was 1.9 W/mK and the density 1.82 g/cm³. The pasty mass according to the invention has good processibility, high thermal conductivity and low density, and is of very good suitability for use in electronic components.

The combustibility test according to example 10 gave a weak flame appearance, an afterflame time of less than 1 second, and no burning drops.

1-12. (canceled)

13. Non-crosslinkable, heat-conducting silicone composition (Y) comprising
5-50% by volume of at least one non-crosslinkable silicone composition (S) and
50-95% by volume of at least one thermally conductive filler (Z) having a thermal conductivity of at least 5 W/mK, with the proviso that
the non-crosslinkable, thermally conductive silicone composition (Y) has a thermal conductivity of at least 0.6 W/mK, and that
at least 20% by volume of metallic silicon particles that are present as thermally conductive fillers (Z) fulfil the following features:
a) their median diameter x50 is in the range of 30-200 μm;
b) they are predominately rounded, and characterized in that the width/length ratio (aspect ratio w/l) is at least 0.76;
c) their distribution range SPAN ((x90−x10)/x50) is at least 0.28.

14. The non-crosslinkable silicone composition (Y) according to claim 13, wherein the non-crosslinkable silicone composition (S) contains organopolysiloxanes (T) that have the following properties:
they are linear, branched or cyclic,
end-capped at both ends or singly Si—OH terminated or singly alkoxy-silyl terminated,
the Si-bonded side and end groups R¹ are independently substituted or unsubstituted C1 to C18 hydrocarbon groups.

15. The non-crosslinkable silicone composition (Y) according to claim 14, characterized in that the non-crosslinkable silicone composition (S) additionally contains rheology additives (E) that serve to adjust its stability under load.

16. The non-crosslinkable silicone composition (Y) according to claim 13, wherein it contains at least 25% by volume of metallic silicon particles as thermally conductive fillers (Z).

17. The non-crosslinkable silicone composition (Y) according to claim 13, wherein, aside from the metallic silicon particles (Z), it contains only one to three further thermally conductive fillers (Z).

18. The non-crosslinkable silicone composition (Y) according to claim 13, wherein, aside from the metallic silicon particles (Z), it contains not more than 24% by weight of a further thermally conductive filler (Z) having a density of greater than 5.0 g/cm³.

19. The non-crosslinkable silicone composition (Y) according to claim 13, wherein, aside from the metallic silicon particles (Z), it contains not more than 60% by weight of a further thermally conductive filler (Z) having a density of greater than 3.0 g/cm³.

20. The non-crosslinkable silicone composition (Y) according to claim 13, wherein the metallic silicon particles (Z) have a sphericity value SPHT of at least 0.75.

21. The non-crosslinkable silicone composition (Y) according to claim 13, wherein the median diameter x50 of the metallic silicon particles is in the range of 40-180 μm.

22. The non-crosslinkable silicone composition (Y) according to claim 13, wherein the metallic silicon particles (Z) fulfil the following further feature:
d) they contain not more than 1.5% by weight of silicon particles smaller than 2 μm.

23. A process for producing the non-crosslinkable silicone compositions (Y) according to claim 13 by mixing the individual components.

24. A thermal paste for dissipation of heat from heat generators in electronic apparatuses comprising the non-crosslinkable silicone composition (Y) according to claim 13.
